(19) United States
(12) Patent Application Publication
(10) Pub. No.: US 2014/0316826 A1
(43) Pub. Date: Oct. 23, 2014

(54) WIRELESS CARRIER PLATFORM FOR SERVICE APPLICATIONS

(71) Applicant: DEUTSCHE TELEKOM AG, Bonn (DE)

(72) Inventors: Angela NICOARA, San Jose, CA (US); Arno PUDER, San Francisco, CA (US)

(73) Assignee: Deutsche Telekom AG, Bonn (DE)

(21) Appl. No.: 13/867,194

(22) Filed: Apr. 22, 2013

(51) Int. Cl. G06Q 30/06; G06Q 30/02; G06Q 10/02

(52) U.S. Cl. CPC G06Q 30/0635; G06Q 10/02; G06Q 30/0257
USPC 705/5; 705/26.81; 705/14.55

(57) ABSTRACT

A method for providing customized service applications relating to specific transactions with merchants to users of mobile devices includes: receiving and storing a service application template corresponding to a merchant; receiving a manifest including information relating to a specific transaction between the merchant and a user of a mobile device; extracting the information relating to the specific transaction from the manifest; generating a customized service application for the user based on the service application template and the extracted information; and transmitting the customized service application to the mobile device corresponding to the user.

### FIELD

The present invention is related in general to wireless communications and in particular, but not exclusively, to a platform for providing service applications to mobile devices.

### BACKGROUND

The explosion of smartphones and tablets has led to a rapid increase in new applications and services. End users of such mobile devices want to be connected everywhere and anytime to the Internet and request a high number of different applications and services. Applications are conventionally distributed through “app stores” controlled by the owners of the platforms corresponding to the mobile devices (e.g., the Android or iOS platforms).

The app stores allow users to search and download applications. They support a pull model where the user has to initiate the download of an application explicitly. A user learns about an application either through word-by-mouth or browsing the app store. A user may download and install an application that the user considers useful. Applications are generally not personalized after download and installation, and often need to be configured or customized before or during use. When the application is no longer useful to the user, the user may uninstall the application, or leave it installed and simply stop using it.

### SUMMARY

In an embodiment, the present invention provides a method for providing customized service applications relating to specific transactions with merchants to users of mobile devices. The method includes: receiving and storing a service application template corresponding to a merchant; receiving a manifest including information relating to a specific transaction between the merchant and a user of a mobile device; extracting the information relating to the specific transaction from the manifest; generating a customized service application for the user based on the service application template and the extracted information; and transmitting the customized service application to the mobile device corresponding to the user.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a general operating environment suitable for embodiments of the present invention;

FIG. 2 illustrates exemplary components of a general client mobile device suitable for embodiments of the present invention;

FIG. 3 is a block diagram illustrating the transmission of applications to mobile devices through conventional methods and through embodiments of the present invention;

FIG. 4 is a block diagram illustrating components of the server-side and client-side service application infrastructure for an embodiment of the present invention;

FIG. 5 is a flowchart illustrating a process for providing a personalized service application based on a manifest and a service application template in an embodiment of the present invention;

FIG. 6 is a block diagram illustrating the modules of the client-side execution platform for service applications in one exemplary embodiment of the present invention; and

FIGS. 7-11 are screen captures from an exemplary embodiment of a transit-related service application.

### DETAILED DESCRIPTION

Embodiments of the present invention provide a wireless carrier platform that allows management of service applications, including management of the lifecycle of the application and the functionality and information provided by the application, from an infrastructure perspective. This wireless carrier platform is referred to herein as a “Ubiquitous Market” or “UbiMarket”, and provides a push model for customized service application that customers may receive, for example, by opting-in to receive customized service applications pertaining to a corresponding purchase. In contrast to the convention pull model for mobile device applications, which requires customers to manually search for, install, and customize their application, the push model provided by UbiMarket allows for dynamically pushing, executing, updating, and removing customized/personalized service applications to and from customers' mobile devices. In an embodiment, these service applications are designed to deliver value-added services to customers with respect to purchases made with a merchant, with the service applications being customized for the specific product or service purchased from the merchant. Such value-added services include automatic distribution of information and coupons to the customer's mobile device. Further, the service application may be provided with a predetermined lifecycle tied to the characteristics of the specific product or service, with the service application being automatically removed at the end of its lifecycle.

The UbiMarket platform provided by embodiments of the present invention allows for many advantages over the conventional pull model for obtaining mobile device applications. One of these advantages includes allowing customers (and wireless carriers) to bypass conventional app stores. Instead of requiring customers and carriers to go through a conventional app store controlled by the mobile device platform owner, carriers may directly facilitate interaction between customers and merchants through the UbiMarket platform. Thus, the UbiMarket platform gives wireless carriers (i.e., the operators of wireless networks) control over service application assets and allows the wireless carriers to have a greater role (and potential revenue source) in providing mobile applications from merchants and developers to customers (conventionally the wireless carriers have been operating in the role of merely being the pipeline for transactions between customers and merchants/developers via the mobile device platform owners' app stores).

Another advantage is that UbiMarket provides customers with service applications in an adaptive and convenient manner, where the service applications are personalized, executed, updated, and removed without the customer having to search for a desired application and manually complete each of those tasks.

Further, in an embodiment, UbiMarket utilizes HTML5 and is cloud-friendly and standards-based, so as to allow for cross-platform integration using a robust application programming interface (API). This allows for broad compatibility that gives a broad variety of merchants and application developers the ability to design and implement customized service applications to suit their customers' specific needs.

Three exemplary use cases for embodiments of the present invention are provided below to generally illustrate the overall differences between the wireless carrier platform (i.e., UbiMarket) provided by embodiments of the present invention and the conventional pull model for mobile device applications.
Transit Service Applications: A customer purchases a ticket for traveling from one location to another. Once the sale of the ticket is complete, the transit system (i.e., the “merchant”) offers the customer a service app as a value added service for the duration of the trip. If the customer agrees, the service app is pushed to the customer's smartphone automatically, without requiring the customer to explicitly download the service app from an app store. The service app is pre-configured with the customer's itinerary so no customization by the customer is required. Once the service app is installed on the customer's device, it offers support and additional information for the itinerary. For example, based on the customer's current location, the service app can advise when it is time to leave for the departure station. Once arriving at the departing station, the service app can offer additional information such as a station map for easier navigation. The service app can also react dynamically to changes such as delays, for example, by notifying the customer and/or providing alternative travel options. If the customer misses a connection, the service app can automatically rebook for a later connection. The service app then removes itself from the customer's mobile device at the end of the trip.
Sports/Entertainment Service Applications: A customer purchases a ticket to a sports or other entertainment event. At the time of purchase, the customer is offered a service app to enhance the experience of the sports event. Provided the customer opts in to receiving a service app, it will enrich the customer's experience of the sports or entertainment event by offering additional information and services. The service app pushed to the customer's device is pre-configured with the details of the sport event. Upon arriving at the event, the service app can help the customer navigate the facility. The service app can offer discounts to be used at concession stands. During the sports or entertainment event, the service app can provide further information and/or statistics in real-time on the game or event in progress. At the end of the game or event, the service app automatically removes itself from the customer's mobile device.
Shopping Mall Service Application: Customers may opt in to receive unsolicited service apps that are automatically pushed to the customer's device in certain situations. For example, shops at a mall may offer special deals to customers through a service app. Such offers and/or the downloading of a service app could be triggered by location. In one example, when a customer enters a mall, a service app is pushed to his device based on the geolocation associated with the mall. Similarly, the service app is removed automatically when the customer leaves the mall. While inside the mall, the service app offers special deals for respective shops located in the mall.

In contrast to conventional mobile device applications obtained through an app store, these service apps discussed in the above exemplary usage scenarios allow for automatic installation based on a trigger event (e.g., purchase of the application, consent by the customer, a certain date/time, arrival at a geographic location, etc.), for personalization/customization without specific customer input to configure the application (e.g., the customer does not need to enter information such as a ticket number into the application; the application is already pre-configured with details of a sales transaction and/or other information when pushed to the customer's mobile device), for automatic removal at the end of their lifecycles, and do not require the customer and merchant to go through an app store to deliver the service apps to the customers (allowing a wireless carrier to facilitate transactions between the merchant and customer directly through an infrastructure managed by the wireless carrier). A summary of some of these differences in an exemplary embodiment of the UbiMarket platform is represented in the table below:

TABLE 1
Comparison between Conventional Mobile Applications and UbiMarket Service
Applications

| | Apps | Service Apps |
|---|---|---|
| Hosted by: | App store (e.g., Apple AppStore, | UbiMarket Repository |
| | Google Play) | |
| Ownership | Owner of mobile platform (e.g., | Wireless carrier |
| | Apple/Google) | |
| Installation | Manually requested by user | Automatically pushed onto |
| | through app store (pull) | device (with user approval) |
| Deinstallation | Manually initiated by user | Automatically at the end of |
| | | service lifecycle |
| Implementation | Native language of platform | HTML5 |
| | (e.g., Java, Objective-C) | |
| Execution Platform | Mobile Device OS | UbiMarket Execution Platform |
| Cross-platform | No | Yes |
| Compatibility? | | |
| Pre-Customized? | No | Yes |

Before getting into the specific details regarding the operation and architecture of the UbiMarket platform, a general overview of an exemplary operating environment and exemplary mobile devices is provided below. It will be appreciated that the operating environment and mobile device provided below are merely illustrative, and embodiments of the present invention are not limited thereto.

### Illustrative Operating Environment

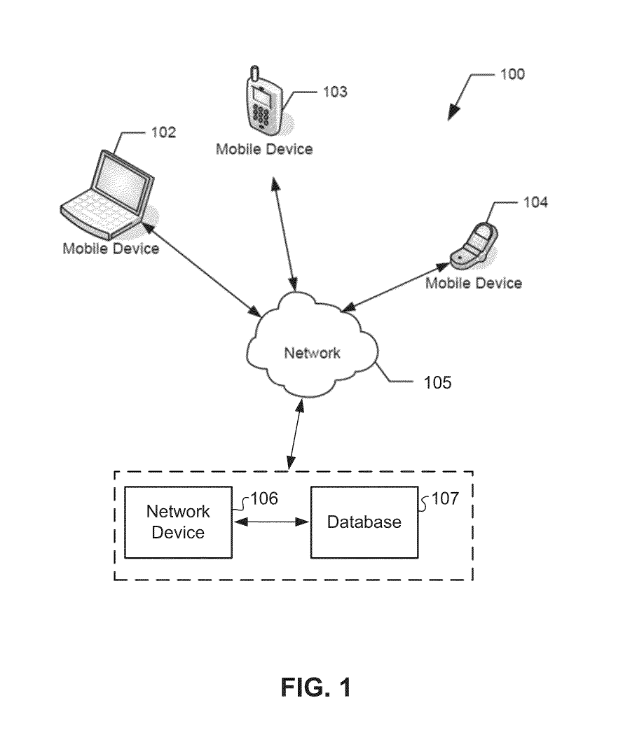

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes mobile devices 102-104, a network 105 (e.g., a wireless network through which the Internet may be accessed), network device 106, and a database 107.

Generally, mobile devices 102-104 may include virtually any mobile computing device capable of receiving data over a network, such as network 105 or the like. Such devices include portable devices such as, cellular telephones, smart phones, radio frequency (RF) devices, infrared devices, Personal Digital Assistants (PDAs), handheld computers, laptop computers, wearable computers, tablet computers, integrated devices combining one or more of the preceding devices, or the like.

Network device 106 may include virtually any computing device such as personal computers, multiprocessor systems, microprocessor-based or programmable consumer electronics, network PCs, or the like. The network device 106 has a processor and a non-transitory computer-readable medium for storing instructions that are executed by the processor, and the network device 106 may include an application server for executing network-based applications and/or a web server for interfacing with the network 105. The network device 106 is in communication with (or may include) a database 107, configured for storage of data and/or applications. In general, the network device 106 should have relatively high processing power and the database 107 should have relatively large disk storage, and, therefore, both are configured to receive as well as supply resources or data to the mobile devices 102-104 in system 100. However, it will be appreciated that any computing device with suitable programming may be implemented as the network device 106 and any computer-readable medium with suitable amount of storage may be used as the database 107.

The network 105, which for example may include the Internet and may further include a wireless network suitable for facilitating communication of the mobile devices 102-104 with the Internet, connects the mobile devices 102-104 to the network device 106 and database 107. The network 105 may include any of a variety of wireless sub-networks that may further overlay stand-alone ad-hoc networks, or the like, to provide a connection for mobile devices 102-104. Such sub-networks may include mesh networks, Wireless LAN (WLAN) networks, cellular networks, or the like. The network 105 may further include an autonomous system of terminals, gateways, routers, or the like connected by wireless radio links, or the like. These connectors may be configured to move freely and randomly and organize themselves arbitrarily, such that the topology of network 105 may change rapidly.

The network 105 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for mobile devices, such as mobile devices 102-104 with various degrees of mobility. For example, the network 105 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. The network 105 may further include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network includes any communication method by which information may travel between computing devices.

### Illustrative Mobile Device

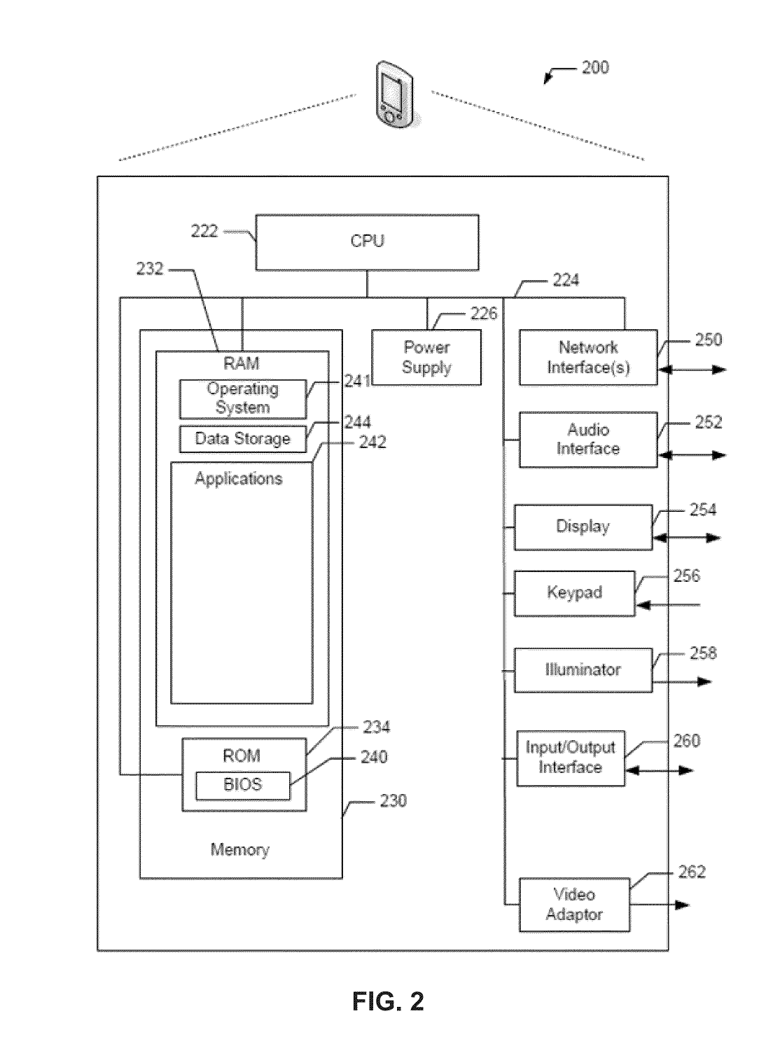

FIG. 2 depicts an exemplary mobile device 200 that may be included in system 100 for implementing the invention. Device 200 may include many more or less components than those shown in FIG. 2. However, the components shown are sufficient to implement an illustrative embodiment for practicing the present invention. Device 200 may represent, for example, one embodiment of at least one of mobile devices 102-104 of FIG. 1.

As shown in the figure, device 200 includes a processing unit (CPU) 222 in communication with a mass memory 230 via a bus 224. Device 200 also includes a power supply 226, one or more network interfaces 250, an audio interface 252, a display 254, a keypad 256, an illuminator 258, and an input/output interface 260. Power supply 226 provides power to device 200. A rechargeable or non-rechargeable battery may be used to provide power. The power may also be provided by an external power source, such as an AC adapter or a powered docking cradle that supplements and/or recharges a battery.

Device 200 can communicate with another computing device directly or indirectly via network interface 250. Network interface 250 includes circuitry for coupling device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone to enable telecommunication with others and/or generate an audio acknowledgement for some action. Audio interface 252 can further be configured to play back music signals by converting digital audio data into voice signals.

Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand. In addition, device 200 may further include video adaptor 262, which is configured to provide video signals to an external display.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the device is powered. In addition, illuminator 258 may backlight these buttons in various patterns when particular actions are performed, such as dialing another device. Illuminator 258 may also cause light sources positioned within a transparent or translucent case of the device to illuminate in response to actions.

Device 200 also comprises input/output interface 260 for communicating with external devices, such as a headset. Input/output interface 260 can utilize one or more communication technologies, such as USB, infrared, Bluetooth™, or the like.

Device 200 typically ranges widely in terms of capabilities and features. For example, a cell phone may have a numeric keypad and a few lines of monochrome LCD display on which only text may be displayed. In another example, a web-enabled mobile device such as a PDA may have a touch sensitive screen, a stylus, and several lines of color LCD display in which both text and graphics may be displayed. In still another example, a multimedia-enabled mobile device such as laptop may include a multimedia application 245 such as a video player application, which is configured to render images, videos streams, audio signals, or the like through a multimedia interface such as a color LCD or LED screen or a microphone. In still another example, device 200 may also include a browser application configured to receive and display graphics, text, multimedia, or the like, employing virtually any web-based language, including a wireless application protocol messages (WAP), or the like. For example, the browser application is enabled to employ Handheld Device Markup Language (HDML), Wireless Markup Language (WML), WMLScript, JavaScript, Standard Generalized Markup Language (SMGL), HyperText Markup Language (HTML), extensible Markup Language (XML), or the like, to display and send information.

### UbiMarket Operation and Architecture

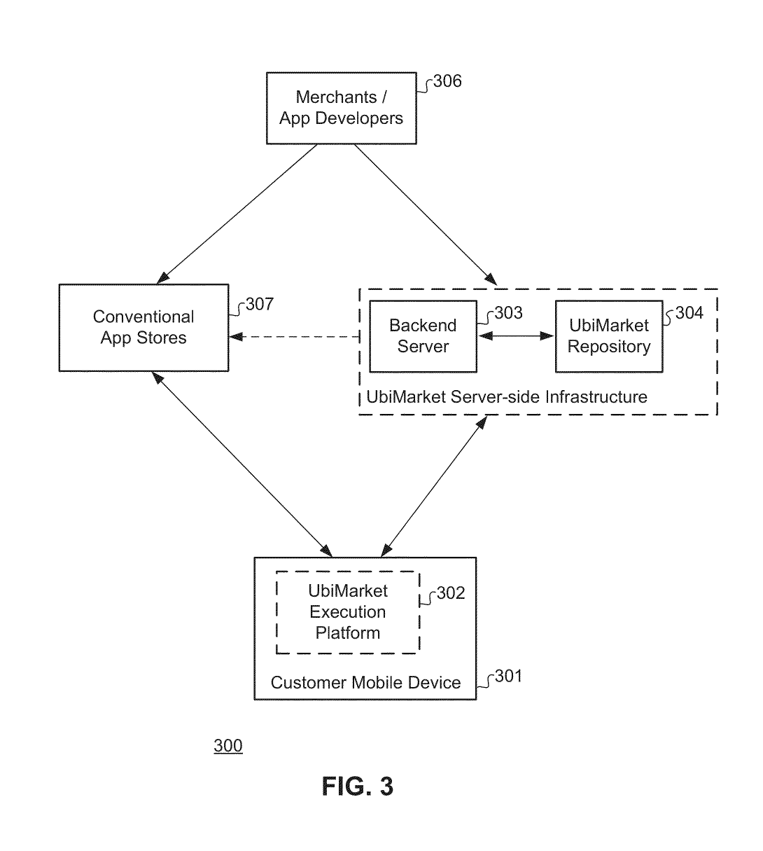

Turning now to FIG. 3, a diagram 300 is shown illustrating the high-level architecture of the UbiMarket infrastructure (as well as the high-level architecture for obtaining mobile device applications through a conventional app store). An exemplary mobile device 301 (e.g., as discussed above with respect to FIG. 2) having the UbiMarket Execution Platform 302 installed thereon is connected to a backend server 303 (for configuring and retrieving service applications) and a UbiMarket Repository 304 (for storing service applications and related information) through a network (e.g., as discussed above with respect to FIG. 1). The UbiMarket infrastructure in this exemplary embodiment follows a client-server model, and the UbiMarket Execution Platform 302 is part of the client-side layer installed at the client—i.e., the mobile device 301. Together with the backend server 303 and the UbiMarket Repository 304, the UbiMarket client-server infrastructure allows service applications to be pushed onto, executed by, updated, and removed from the mobile device 301. It will be appreciated that the UbiMarket Execution Platform 302 may be pre-installed onto the mobile device 301 (e.g., by a wireless carrier that provides the mobile device 301 to a customer) such that the UbiMarket Execution Platform 302 is available to a customer upon purchase of the mobile device 301. In an alternative embodiment, the UbiMarket Execution Platform 302 may be downloaded and installed on the mobile device 301 by the customer through a conventional app store, or may be automatically pushed onto the mobile device 301, for example, when the customer consents to receiving pushed service apps in connection with a transaction with a merchant.

Merchants 306 (and application developers) utilize an API associated with the backend server and UbiMarket Repository to build a wide range of service apps. When a service app is ready, the merchant 306 uploads the service app to the UbiMarket Repository 304. Upon a trigger event (such as when a customer consents to receiving service apps in connection with a transaction), the service app is personalized by the backend server 303 and pushed to the customer's mobile device 301. In one embodiment, the service app may be deployed to the customer's mobile device 301 through the user of NFC (Near Field Communication) technology, for example, by holding the mobile device 301 in proximity to a merchant's sales terminal (in this example, the sales terminal may retrieve a service app template and customize the template based on specific transaction-related information, or the sales terminal may communicate with UbiMarket server-side components over a network to receive a customized service app to be pushed to the mobile device 301 via NFC).

When the service app reaches the end of its lifecycle, for example, at the end of the service to which the application is related, the service app may be automatically removed.

FIG. 3 also illustrates the high-level architecture for obtaining mobile device applications through a conventional app store. For a conventional mobile device application, a merchant 306 (or application developer) is required to build a mobile application specifically in the native language of the mobile device platform through which the app will be executed. When completed, the merchant 306 then makes the application available through the mobile device platform owner's app store 307. When a customer wants to download and install a mobile application onto the customer's mobile device 301, the customer must send a request for that application to the app store 307, and the application is pulled from the app store 307 to the mobile device 301 for installation.

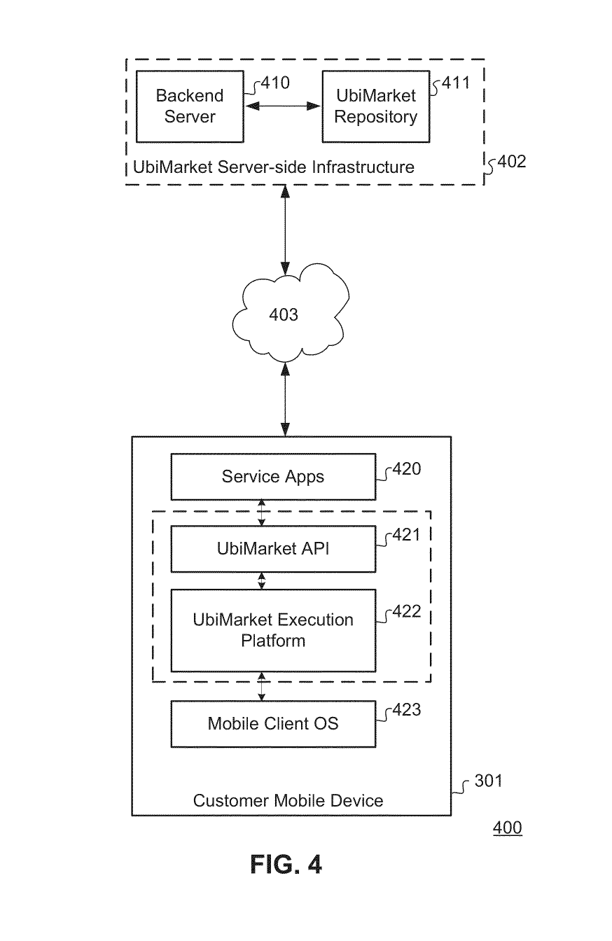

Turning now to FIG. 4, a diagram 400 illustrating the relationship between the mobile client 401 and the server-side 402 UbiMarket backend server 410 and UbiMarket Repository 411 is depicted. The UbiMarket server-side 402 includes the backend server 410, which is in charge of managing, pushing, and supporting software updates and synchronization mechanisms with the mobile clients 401 with respect to the UbiMarket client-side infrastructure (the UbiMarket API 421 and UbiMarket Execution Platform 422) and with respect to Service Apps 420. The backend server 410 interfaces with external clients through a network 403 such as the Internet and acts as a bridging entity between mobile clients 401 and the UbiMarket Repository 411. The UbiMarket Repository 411 is a database that stores and manages all types of supported service app templates that are used to generate the personalized service apps 420 pushed to the mobile clients 401.

The mobile client 401 loads and executes service apps through the UbiMarket Execution Platform 422. The UbiMarket Execution Platform 422 and the Service Apps 420 are separate layers that are independent of one another and interact through a communication protocol (e.g., HTTP) and a well-defined UbiMarket API 421. The UbiMarket Execution Platform 422 also interfaces with the Mobile Client OS 423 (i.e., the mobile device platform—e.g., Android, iOS, etc.) to provide the functionality associated with the Service Apps 420 to the customer through the mobile device 401. The mobile device 401 ultimately controls execution of the service apps 420 through the Mobile Client OS 423.

The mobile device 401 is connected to the UbiMarket backend server 410 through a network (e.g., a wireless network that utilizes the Internet as discussed above with respect to FIG. 1), and the mobile device 401 can request software updates for the Service Apps 420 or for the UbiMarket client-side infrastructure on the fly. Mobile devices 401 connect to the UbiMarket backend server 410 via the network 403 through a communication protocol (e.g., HTTP).

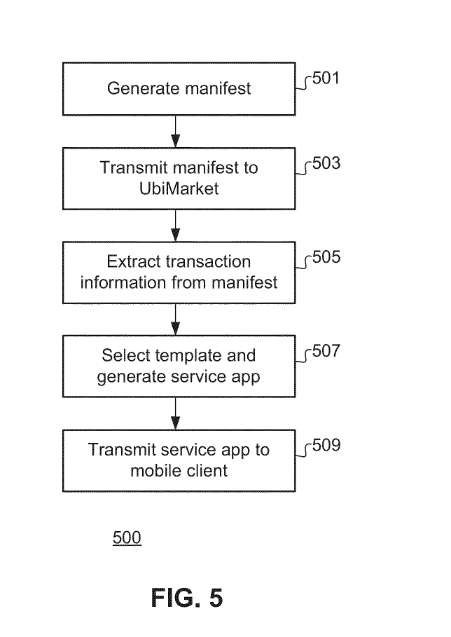

Turning now to FIG. 5, a flowchart 500 is depicted illustrating an exemplary overall process for generating and pushing personalized service apps to mobile devices. At step 501, in connection with the completion of a sales transaction, a merchant creates a manifest containing details associated with the sales transaction. For example, for a transit-related manifest, the merchant extracts first name, last name, starting location, destination location, and payment-related information such as credit card type from the sales transaction to create the manifest. In another example, for a sporting event-related manifest, the merchant extracts first name, last name, event, location, and payment-related information to create the manifest. In one embodiment, the manifest is a generic manifest that can be used for different merchants and different types of transactions. For example, the manifest includes a plurality of fields, some of which are used by only certain types of transactions, and when creating a personalized service app for a specific type of transaction, only the information relevant to that type of service app is extracted from the generic manifest.

At step 503, the merchant then sends the manifest to the UbiMarket Repository (e.g., via a network and via the backend server). The UbiMarket Repository stores the manifest containing the information relating to the specific sales transaction, as well as storing service app templates corresponding to different types of sales transactions and different merchants. It will be appreciated that service app templates are developed by the merchants or application developers and uploaded to the UbiMarket Repository prior to the transmission of any specific transaction-related manifests utilizing those service app templates. These service app templates allow dynamic building and generation of personalized service apps because they are customizable to fit the details of each transaction. In one embodiment, the templates are implemented in HTML5 using JavaScript, HTML, and CSS. Using HTML5 technology facilitates porting of the UbiMarket Execution Platform to various mobile devices, and any service app can be arbitrarily extended through the addition of new components. In contrast, conventional mobile app distribution models rely on different native languages for different mobile platforms (e.g., Objective-C and Java), making it difficult and cumbersome to make mobile applications executable across different mobile device operating platforms.

At step 505, relevant information is located in and extracted from the manifest by the UbiMarket Repository or the backend server, and at step 507, the UbiMarket Repository or the backend server selects the appropriate service app template and generates a personalized service app from the template using the extracted information (i.e., by merging the extracted information with the corresponding service app template). At step 509, the generated personalized service app, which includes the transaction-specific information from the manifest, is pushed to the mobile client corresponding to the transaction by the backend server.

It will be appreciated that different implementations with certain steps being performed by the UbiMarket Repository and certain steps being performed by the backend server are possible. For example, the Repository could include an application server that extracts details from the manifest profile and generates personalized service apps while the backend server acts as the interface between the Repository and the network for retrieving the manifest information and pushing the personalized service apps to mobile devices. In another example, the Repository may just be a database for storing information while the information extraction and generation of personalized service apps is performed by the backend server.

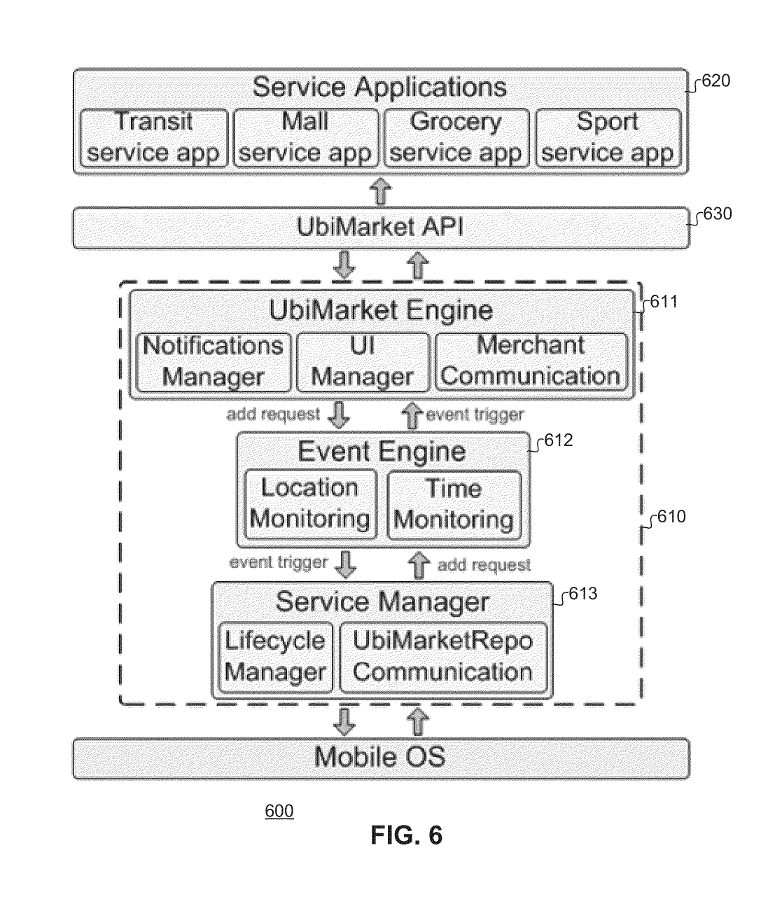

Turning now to FIG. 6, a diagram 600 is depicted illustrating components of a mobile device in further detail in an exemplary embodiment of the client-side UbiMarket infrastructure. The UbiMarket Execution Platform 610 is shown as including three principal modules—the UbiMarket Engine 611, the Event Engine 612, and the Service Manager 613—for facilitating the execution and management of service apps at the mobile client. It will be appreciated that these modules may be implemented as processor-executable instructions stored on a non-transient computer-readable medium, and when executed, these modules provide the decision logic governing the pushing, execution, updating, and removal of service apps with respect to the mobile device.

The Service Manager 613 manages the service app components and performs execution of the service apps at the mobile device. Once a service app 620 is pushed to a mobile device, the Service Manager 613 instantiates the service app. The Service Manager 613 includes a Lifecycle Manager that is responsible for managing the lifecycle of various service apps. When a user navigates through and to/from a service app, the service app transitions between different states of its lifecycle. For example, when a service app executes for the first time, it comes into the foregoing of the screen of the mobile device and has user focus. If the user starts or switches to a different app, the service app moves into the background where it is hidden from view, but the instance and status of the service app remain intact. The Lifecycle Manager provides support to control the behavior of the service app when the user leaves and re-enters the service app (e.g., when the user starts or switches to another app and the service app is moved into the background), and also handles the installation and un-installation of service apps. The Service Manager 613 further includes a repository communication module that handles the inter-process communication between the mobile device and the UbiMarket server-side infrastructure. The inter-process communication between the client and the UbiMarket server-side infrastructure is facilitated through a communication protocol and a well-defined API.

The Event Engine 612 is responsible for registering and unregistering service app events and informing other UbiMarket-related modules regarding the occurrence of certain events, for example, when the user of the mobile device arrives at a specific location or when a specific time has been reached. The Event Engine 612 includes monitor modules to keep track of any activity relevant to the management and execution of service apps. For example, it includes a location monitoring module for monitoring the location of the mobile device and a time monitoring module for monitoring the current time. The Event Engine 612 may also include other monitors, such as a data monitor for monitoring data transmitted and received over any network interfaces and a wireless monitoring module for monitoring connectivity status, signal strength, and information relating to access points. Further, the Event Engine 612 has a modular design that allows other monitors to be added into the system and that easily allows extension of the capabilities of existing monitors. The monitors may be implemented as background services that are turned on during device start-up and run so long as the device is running.

The UbiMarket Engine 611 includes three major modules—the Notifications Manager, the UI Manager, and the Merchant Communication module. The UI Manager controls the placement and appearance of service app windows in the graphical interface of the mobile device. The Merchant Communication module facilitates the overall communication process between the mobile device and the merchant backend (e.g., servers associated with the merchant for completing transactions and/or executing or updating service apps). The Notifications Manager is responsible for notifying the user of the mobile device of specific event occurrences. In one embodiment, the Notifications Managers periodically checks if a notification needs to be provided to the user. For example, at a specific time, or if the user arrives at a specific location, the notification system alerts the user of a service app-related event (i.e., the time or the arrival acts as a trigger for providing a notification message to the user). In one embodiment, the user can pull down a notifications shade of the mobile device user interface to view details of the notification, and the notifications shade will display the information pertaining to the service app(s) most relevant and useful to the user based on the current time and/or location. The user can also use the mobile device user interface to dismiss service apps or notifications relating to service apps (e.g., by swiping or pressing buttons). The user can also choose to disable notifications for service apps.

FIG. 6 further illustrates the API 630 provided between the UbiMarket Execution Platform 610 and the Service Apps 620. The API 630 allows merchants and application developers to easily create a variety of different service apps (e.g., based on service app templates and manifest information), and also allows for configuration and control of the UbiMarket Engine 611 as discussed above. Further, by implementing the service apps in cross-platform compatible HTML5, these service apps can be written such that they can be executed on various devices regardless of which mobile client operating platform is being used to execute the service apps.

### Example of a Transit Service Application

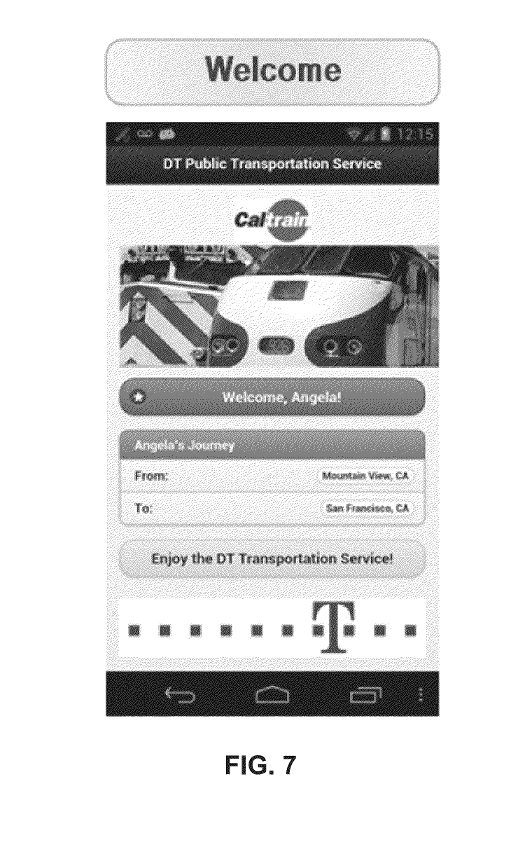

Turning now to FIGS. 7-11, exemplary screenshots are depicted from one exemplary implementation of the UbiMarket infrastructure described above. In this example, a customer has purchased a train ticket for a specific itinerary—from Mountain View, Calif. to San Francisco, Calif. using the Caltrain rail system—and the service app is provided by the wireless carrier “DT” (Deutsche Telekom). FIG. 7 depicts a welcome screen of the service app that is seen by the customer once the customer has purchased a train ticket for that itinerary and the service app has been pushed to the customer's mobile device based on the customer's purchase as a trigger event (assuming the customer has consented to receiving pushed service apps from the wireless carrier generally or for that transaction specifically).

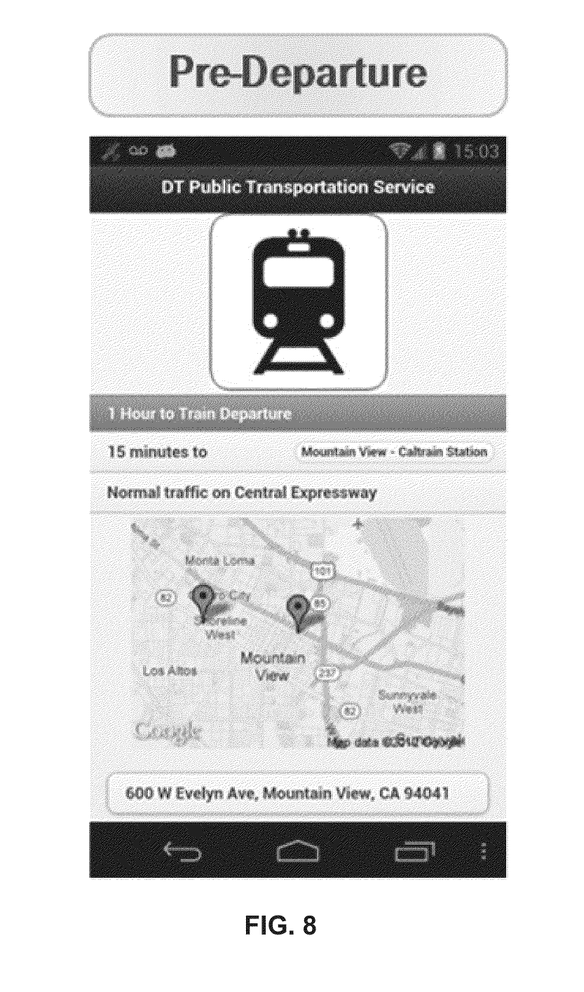

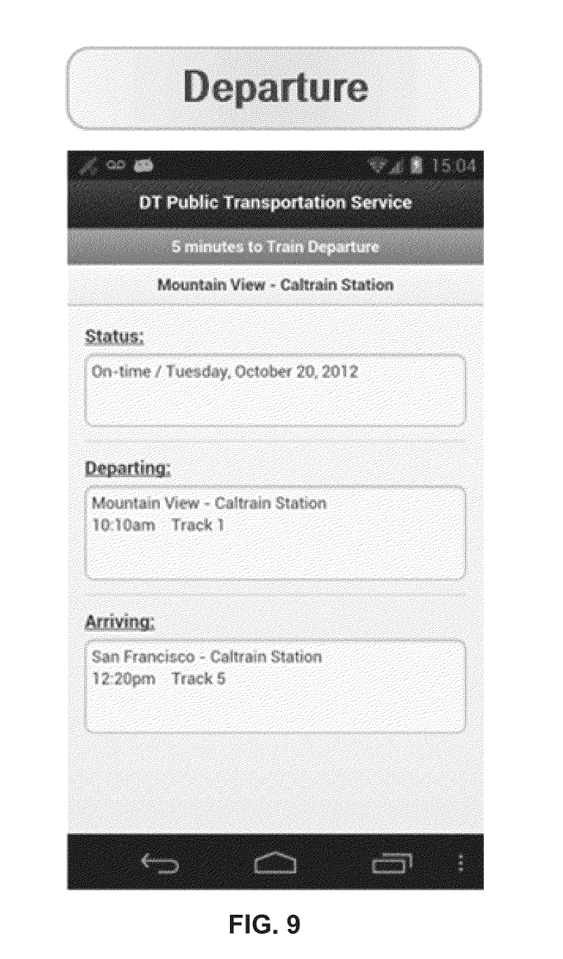

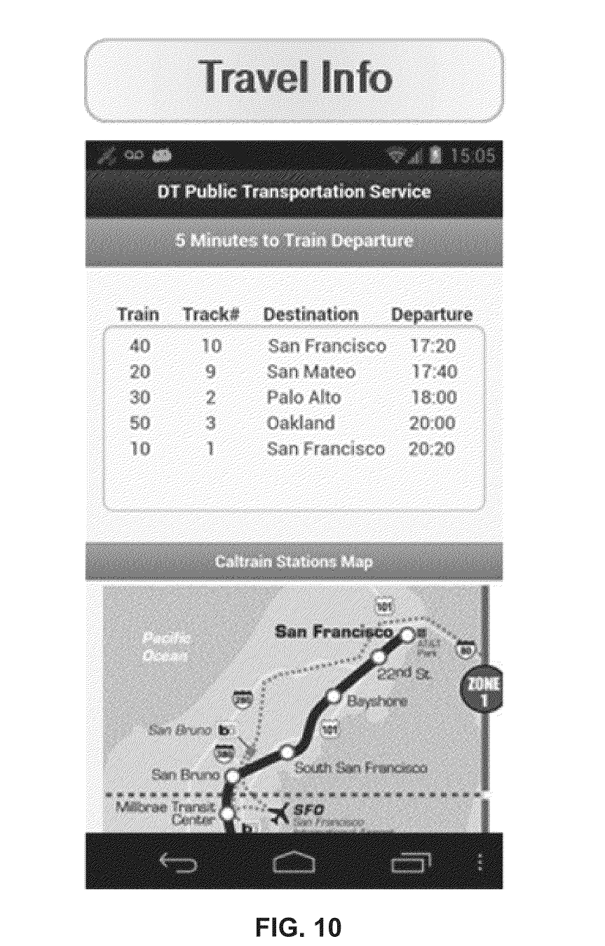

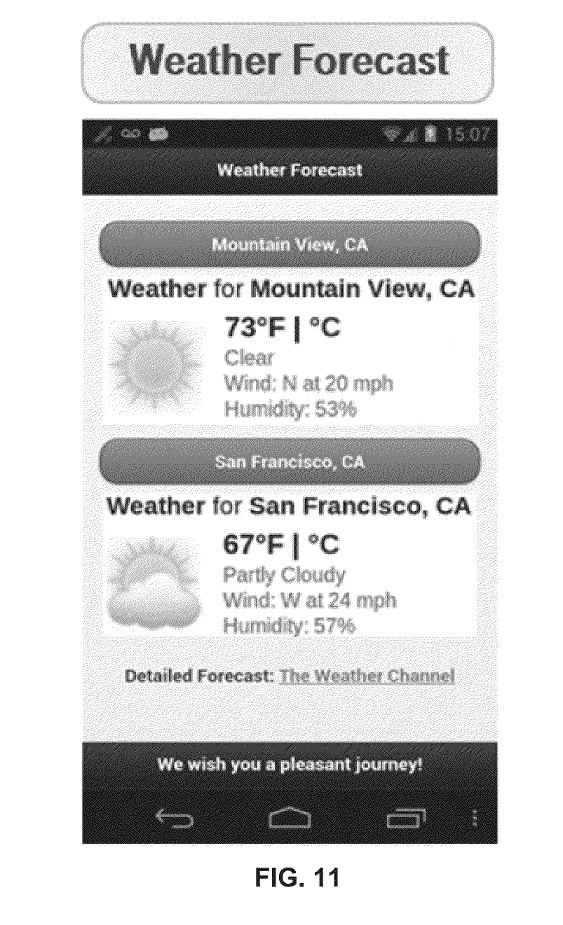

FIGS. 8-11 show value-added services relating to the customer's itinerary that are provided by the service app during the lifetime of the service app. FIG. 8 depicts a pre-departure information screen that provides information useful to the customer such as time remaining until departure, estimated travel time to starting location for the itinerary, traffic conditions, and relevant map information. FIG. 9 depicts a departure information screen that includes status information for the itinerary, as well as detailed information on departure and arrival time and location. FIG. 10 depicts a travel information screen that includes miscellaneous travel information that may be useful to the customer, e.g., information on other trains if the customer wants to take a different route or go to a different destination. FIG. 11 depicts a weather information screen that includes weather information for both the start and destination locations of the customer's itinerary.

Once the final destination is reached—i.e., once the customer arrives at San Francisco, Calif. in this example—the service app is automatically removed from the customer's mobile device.

It will thus be appreciated that embodiments of the present invention provide a wireless carrier-controlled marketplace through which personalized service applications are pushed, executed, updated, and removed with respect to users' mobile devices. While conventional mobile applications require manual download and installation (i.e., a “pull” model) and require manual customization (e.g., by providing credentials for accessing a merchant server or typing in a confirmation number), service apps according to embodiments of the present invention allow for frictionless deployment by using a “push” model and through automatic customization (and further bypasses the need to go through conventional app stores).

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

1: A method for providing customized service applications relating to specific transactions with merchants to users of mobile devices, the method comprising:
receiving and storing a service application template corresponding to a merchant;
receiving a manifest including information relating to a specific transaction between the merchant and a user of a mobile device;
extracting the information relating to the specific transaction from the manifest;
generating a customized service application for the user based on the service application template and the extracted information; and
transmitting the customized service application to the mobile device corresponding to the user.

2: The method of claim 1, wherein the manifest includes a plurality of fields, the plurality of fields including fields for information that does not relate to the specific transaction.

3: The method of claim 1, wherein the service application template is stored with a plurality of other service application templates in a service application template repository.

4: The method of claim 1, wherein a server operated by a wireless carrier receives the service application template, generates the customized service application, and transmits the customized service application to the mobile device.

5: The method of claim 1, wherein the specific transaction is a purchase of a ticket for transit from a starting location to a destination location, and the manifest includes information on the starting location, the destination location, and time of departure.

6: The method of claim 1, wherein the specific transaction is a purchase of a ticket for an entertainment-related event, and the manifest includes information on the location of the event and the time of the event.

7: The method of claim 1, wherein the specific transaction is an agreement to receive special offers from a shopping mall, and the manifest includes information on the location of the shopping mall.

8: The method of claim 1, the method further comprising:
receiving an indication that the user consents to receiving the customized service application.

9: The method of claim 1, wherein the customized service application is automatically transmitted to the mobile device based on completion of the specific transaction.

10: A non-transitory computer-readable medium having processor-executable instructions stored thereon for providing customized service applications relating to specific transactions with merchants to users of mobile devices, the processor-executable instructions, when executed by a processor, causing the following steps to be performed:
receiving and storing a service application template corresponding to a merchant;
receiving a manifest including information relating to a specific transaction between the merchant and a user of a mobile device;
extracting the information relating to the specific transaction from the manifest;
generating a customized service application for the user based on the service application template and the extracted information; and
transmitting the customized service application to the mobile device corresponding to the user.

11: The non-transitory computer-readable medium of claim 10, wherein the manifest includes a plurality of fields, the plurality of fields including fields for information that does not relate to the specific transaction.

12: The non-transitory computer-readable medium of claim 10, wherein the service application template is stored with a plurality of other service application templates in a service application template repository.

13: The non-transitory computer-readable medium of claim 10, wherein non-transitory computer-readable medium is part of a server operated by a wireless carrier.

14: The non-transitory computer-readable medium of claim 10, wherein the specific transaction is a purchase of a ticket for transit from a starting location to a destination location, and the manifest includes information on the starting location, the destination location, and time of departure.

15: The non-transitory computer-readable medium of claim 10, wherein the specific transaction is a purchase of a ticket for an entertainment-related event, and the manifest includes information on the location of the event and the time of the event.

16: The non-transitory computer-readable medium of claim 10, wherein the specific transaction is an agreement to receive special offers from a shopping mall, and the manifest includes information on the location of the shopping mall.

17: The non-transitory computer-readable medium of claim 10, wherein the processor-executable instructions, when executed, further cause the following steps to be performed:
receiving an indication that the user consents to receiving the customized service application.

18: The non-transitory computer-readable medium of claim 10, wherein transmission of the customized service application is automatic based on completion of the specific transaction.

19: A system providing customized service applications relating to specific transactions with merchants to users of mobile devices, the system comprising:
a repository for storing service application templates;
a mobile device; and
a server in communication with the repository for generating customized service applications based on the stored service application templates and based on information relating to a specific transaction between a merchant and a user of the mobile device;
wherein the mobile device is configured to receive the customized service application from the server, and wherein the mobile device comprises a service application execution platform that communicates with a mobile device operating platform for executing the service application on the mobile device.

20: The system of claim 19, wherein the mobile device further comprises a service application programming interface (API), configured to facilitate communication between the customized service application and the service application execution platform.
